(19) United States
(12) Patent Application Publication
(10) Pub. No.: US 2003/0195006 A1
(43) Pub. Date: Oct. 16, 2003

(54) Smart vocoder

(76) Inventors: Philip T. Choong, Los Altos Hills, CA (US); Tsi-Pin Choong, Los Altos Hills, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/977,337

(22) Filed: Oct. 16, 2001

(51) Int. Cl. H04Q 7/20

(52) U.S. Cl. 455/450; 455/452.1

(57) ABSTRACT

The present invention includes a smart vocoder which selects an optimal vocoder algorithm for encoding a communication. The selection is based on at least one of the following criteria: a) minimizing bandwidth required to transmit the communication; b) minimizing a cost of transmitting the communication; c) increasing the quality of the communication; d) achieving compatibility with a receiving terminal; and e) reducing latency. The selection of the optimal vocoder algorithm occurs during the call setup. The smart vocoder can select a low bit rate vocoder algorithm if bandwidth is scarce. The smart vocoder can also select a vocoder algorithm which allows the call to be routed over a low cost network. A lossless compressor can be used to compress the encoded communication signal, creating extra bandwidth for the insert of error correction bits. The smart vocoder can be incorporated into a DSP or one or more ASICs.

### FIELD OF THE INVENTION

The present invention relates generally to intelligent coding of voice signals routed through telecommunication networks. More specifically, the present invention relates to a system for selecting a method of encoding voice signals which is optimally suited to match network conditions.

### BACKGROUND OF THE INVENTION

Improving signal quality and conserving bandwidth are two of the most important goals of telecommunications technology. One of the obstacles to reaching these goals is the heterogeneous telecommunication transmissions network in place that sometimes utilizes antiquated technology. The telecommunications networks in place today include a combination of transmission systems such as analog, digital, optical, and satellite based systems. When a transmission is sent from one of these systems to another, often one or more conversions must take place. For example, to transmit a voice signal from caller A to caller B, the voice signal may have to be decompressed and then converted from digital to analog and later converted back to digital and recompressed. Additional conversions may be needed to convert between different protocols and between different compression standards. These conversions often degrade the quality of the transmitted voice signal, introduce unnecessary protocol conversion processing delays, and increase the bandwidth required to accommodate the call.

This problem can be illustrated by looking at an example of digital cellular telephones connected to a digital mobile communications network such as a Global System for Mobiles (GSM) (the standard digital cellular phone service in Europe, Japan, Australia and many other countries) or a Personal Communications Networks/Services (PCN/PCS) (several such networks have been established in North America).

Digital cellular phones connected to these networks typically have built-in “vocoders” for compressing the transmitted digital voice signal. A vocoder is a device for compressing and decompressing a digital speech signal. Instead of transmitting samples of the original speech waveform itself, vocoders compress the speech signal by mapping speech signals onto a mathematical model of the human vocal tract. There are several types of vocoders on the market and in common usage, each having its own set of algorithms associated with the vocoder.

When a digital mobile user A on digital mobile network A places a call to a digital mobile caller B on digital mobile network B, typically multiple conversions of the voice signal are required to transmit the call from user A to user B. For example, assume mobile user A is a PCS user and is placing a long distance phone call to mobile user B on a GSM network. When user A speaks into the mobile phone, the voice signal is digitized by the mobile phone, encoded/compressed by a vocoder and then transmitted to a base station by a radio-frequency (RF) signal. Typically, the encoded voice signal is between 2.4 kb/s and 13 kb/s.

The base station first decodes/decompresses this bit stream into a public switched telephone network (PSTN) compatible 64 kb/s pulse coded modulation (PCM) format and forwards the signal to a mobile switching center that determines the route for the voice signal. PCM is the most common method of encoding a voice waveform signal into a digital bit stream. The PCM signal is a digital signal representing the speech waveform.

The PCM voice signal will then typically be routed to the PSTN's Central Office (CO) through landlines. If necessary, the digital signal may have to be converted to analog and later back to digital. Finally the call will be routed from the PSTN to the designation mobile network B and to a base station B servicing mobile user B. The destination base station B must then convert the received PCM signal back to a vocoder digital format compatible with the destination mobile phone B. The vocoded voice signal is then transmitted by a radio frequency (RF) signal to the destination mobile phone B.

Thus, multiple conversions of the voice signal are required to transmit the call from user A to user B. At a minimum, the vocoded call from A must be converted to a waveform representation such as PCM, and then later reencoded by a second vocoder at base station B. Often, the conversion performed at base station A also involves changing the bandwidth of the voice signal to allow the mobile signal to operate on the other network (mobile network B). The effect of all of these conversions is typically to reduce the quality of the voice signal. The loss is referred to as tandemming loss. This problem is exacerbated when multiple non-PSTN networks are utilized to transmit the voice signal. Even when a mobile user places a call to a mobile user on the same network, mobile networks today typically will perform at least one vocoder to PCM conversion and later convert back to a vocoder format. This is especially true when the voice signals are transmitted through a PSTN network, which often is the case.

Another disadvantage is that this method of routing calls is wasteful of bandwidth. The vocoder signal transmitted by the mobile phone has a very compressed format. When the vocoder signal is expanded by converting to PCM, the resulting PCM signal requires significantly more bandwidth to transmit than the original compressed vocoder signal.

Thus, there is a need for a method of transmitting compressed voice signals through today's communications networks that preserves voice quality and the integrity of the original signal and avoids tandemming loss. Furthermore, there is a need for a method of routing calls that does not waste bandwidth. As telecommunications networks continue to expand, efficient use of bandwidth is always very important because the less bandwidth that is used, the greater the amount of information that may be sent. What is also needed is a system that can provide flexibility in the encoding of voice signals such that the form of voice encoding can be adapted to suit the current network conditions.

### SUMMARY OF THE INVENTION

The present invention comprises a smart vocoder which selects an optimal vocoder algorithm for encoding a communication. The selection is based on at least one of the following criteria: a) minimizing bandwidth required to transmit the communication; b) minimizing a cost of transmitting the communication; c) increasing the quality of the communication; d) achieving compatibility with a receiving terminal; and e) reducing latency. The selection of the optimal vocoder algorithm occurs during the call setup.

The smart vocoder can select a low bit rate vocoder algorithm if bandwidth is scarce. The smart vocoder can also select a vocoder algorithm which allows the call to be routed over a low cost network. A lossless compressor can be used to compress the encoded communication signal, creating extra bandwidth for the insert of error correction bits. The smart vocoder can be incorporated into a digital signal processor (DSP) or one or more application-specific integrated circuits (ASICs).

### BRIEF DESCRIPTION OF THE DRAWINGS

FIG. 1 depicts a block diagram illustrating an exemplary system utilizing a smart vocoder of the present invention.

FIG. 2 depicts a block diagram illustrating an example of a conventional communication system where the calling terminal 102 does not have the smart vocoder of the present invention.

FIG. 3 depicts a block diagram illustrating a simple example of smart vocoder 112 operation.

FIG. 4 depicts a block diagram illustrating another example of a communications system.

FIG. 5 depicts a block diagram illustrating an example of a mode of smart vocoder operation for routing a call through a low cost network.

FIG. 6 depicts a block diagram illustrating operation of a smart vocoder that has the capability to select a vocoder and a lossless compressor.

### DETAILED DESCRIPTION OF THE INVENTION

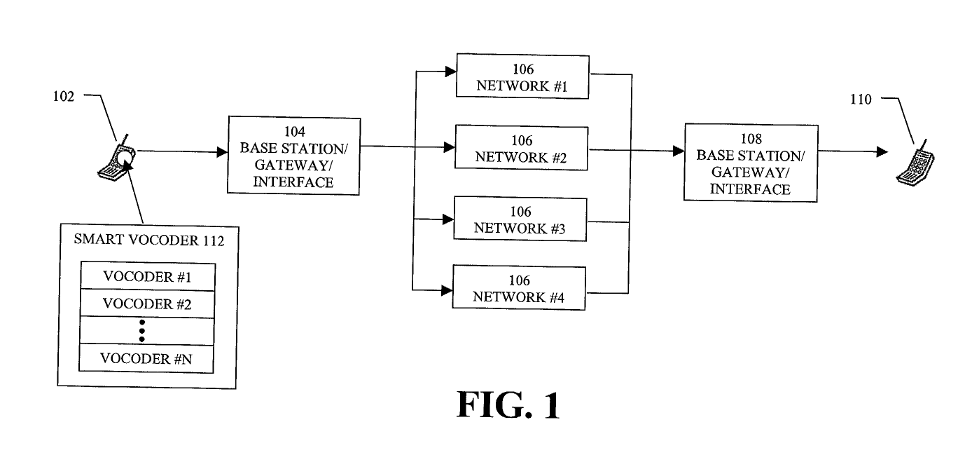

FIG. 1 depicts a block diagram illustrating an exemplary system utilizing a smart vocoder of the present invention. A calling terminal 102 places a call to a called terminal 110. Calling terminal 102 could be a wireless terminal such as a cellular telephone. Calling terminal 102 could also be a terminal in a wired network.

Calling terminal 102 places a call to called terminal 110. Calling terminal connects to a base station or gateway or interface 104. Base station/gateway/interface 104 routes the call via a network 106 to a destination base station/gateway/interface 108. Base station/gateway/interface 108 then routes the call to called terminal 110. In the example depicted in FIG. 1, several different networks 106 are shown (networks #1-4). As will be explained in more detail below, the call can be routed through any one of these networks. In the simplest embodiment of the system, there is only one network 106.

Calling terminal 102 contains a smart vocoder 112 of the present invention. There are many different types of vocoder algorithms. One of the older standard vocoder algorithms is LPC-10 (linear predictive coding) which transmits at a rate 2.4 kbit/sec. Newer vocoder algorithms have been developed which provide improved voice quality and/or lower bit rates for transmission such as MELP (mixed-excitation linear predictive coding) which also transmits at 2.4 kbit/sec.

Vocoders which transmit at 2.4 kbit/sec will be referred to herein as “narrowband” vocoders. Vocoders which transmit at less than 2.4 kbit/sec will be referred to herein as “subnarrowband” vocoders.

Smart vocoder 112 includes multiple vocoder algorithms referred to as vocoder #1, vocoder #2, . . . , vocoder #N. During the call setup/signaling process, smart vocoder 112 chooses a particular vocoder algorithm to use for encoding the transmission. The selection of a vocoder algorithm is based on at least one of the following objectives: minimize cost, maximize voice quality, minimize bandwidth usage, achieve compatibility with the called terminal, or reduce latency.

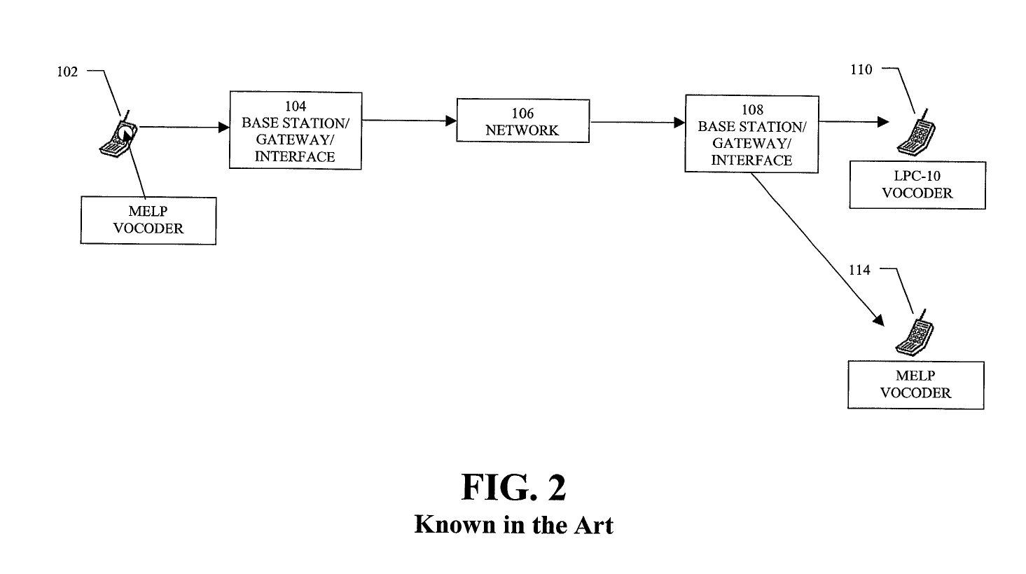

To illustrate the advantages provided by the smart vocoder of the present invention, first the disadvantages of a conventional communications terminal will be discussed with respect to FIG. 2. FIG. 2 depicts a block diagram illustrating an example of a conventional communication system where the calling terminal 102 does not have the smart vocoder of the present invention. In this example, calling terminal 102 only uses the MELP vocoder. Two destination terminals 110 and 114 are shown connected to destination base station/gateway/interface 108. In this example, terminal 110 only uses the older LPC-10 vocoder algorithm, and terminal 114 only uses the newer MELP vocoder algorithm.

Voice transmissions transmitted from calling terminal 102 are thus compressed by the MELP vocoder algorithm and transmitted to base station 104. Because terminal 110 has a different built-in vocoder algorithm, LPC-10, calling terminal 102 cannot communicate directly with called terminal 110 unless some conversion process takes place. Typically, base station/gateway/interface 104 will convert all voice transmissions received from calling terminal 102 (or from other terminals) to 64 kbit/sec PCM format. PCM is a non-compressed waveform representation of the voice transmission. The PCM signal is then transmitted to destination base station 108 where it is converted into the destination vocoder format LPC-10.

This type of conversion from one vocoder format to PCM to a second vocoder format is referred to as a “tandem” connection. There are several disadvantages to a tandem connection. First, it reduces the quality of the voice transmission. Second, it takes up more bandwidth to transmit the call over network 106, because the 2.4 kbit/sec compressed MELP format is expanded to 64 kbit/sec PCM format. Third, it requires the additional conversion process which introduces complexity and adds latency (delay).

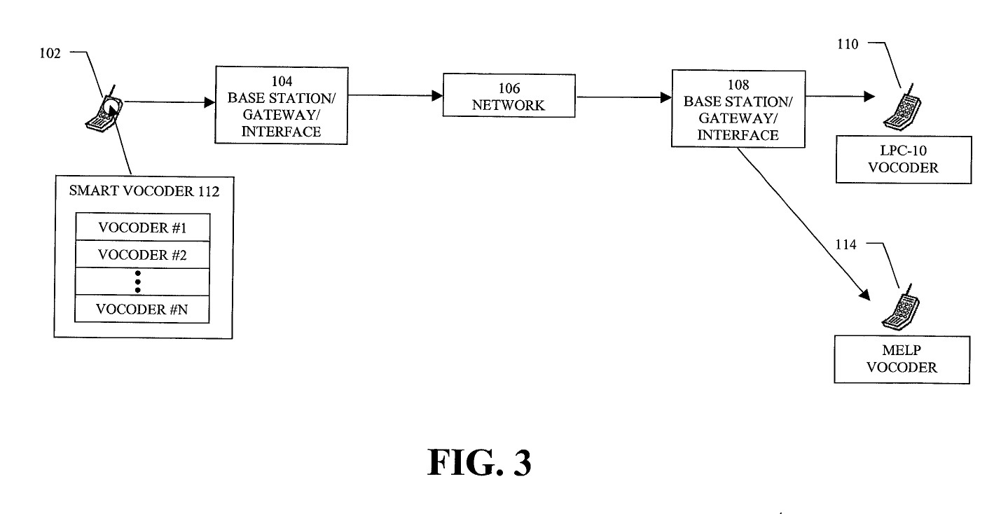

The smart vocoder of the present invention overcomes these disadvantages of the conventional system. FIG. 3 depicts a block diagram illustrating a simple example of smart vocoder 112 operation. This example demonstrates how smart vocoder 112 can choose a vocoder algorithm for voice transmission based on achieving compatibility with the called terminal. FIG. 3 depicts two destination terminals 110 and 114 connected to destination base station/gateway/interface 108. Terminal 110 only uses the older LPC-10 vocoder algorithm. Terminal 114 only uses the MELP vocoder algorithm.

Calling terminal 102 places a call to terminal 110. During the call set-up process, calling terminal 102 and called terminal 110 exchange signaling information. During this call set-up process, calling terminal 102 learns that called terminal 110 uses only the LPC-10 vocoder. Smart vocoder 112 therefore selects the LPC-10 vocoder algorithm to transmit the voice call to terminal 110. Similarly, if calling terminal 102 calls terminal 114, then smart vocoder 112 will select MELP as the vocoder algorithm for transmission. Because the smart vocoder 112 selects a vocoder which is compatible with the vocoder recognized by the called terminal, the calling terminal and the called terminal can communicate directly in that vocoder format. The transmission does not need to be converted to a PCM representation. This preserves bandwidth (because no decompression of the signal is required), preserves the voice quality, and reduces latency.

The above description is an example of how the smart vocoder 112 can select a vocoder to achieve compatibility with the called terminal. Smart vocoder 112 can also select a vocoder to achieve other objectives such as maximizing call quality, reducing bandwidth required, reducing latency, and so forth. This will now be explained in greater detail.

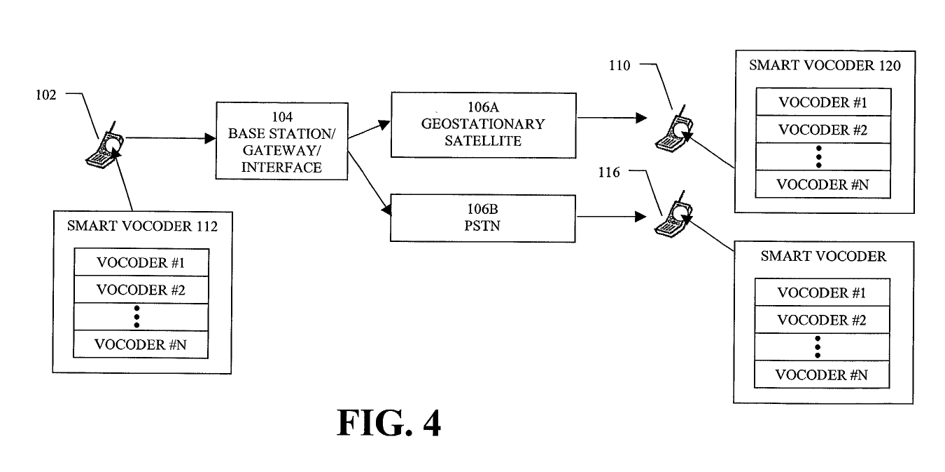

FIG. 4 depicts another example of a communications system. This example illustrates how the smart vocoder 112 can select a vocoder for voice transmission based on conserving bandwidth or maximizing voice quality. In the example depicted in FIG. 4, the called terminals 110 and 116 also contain smart vocoders.

Suppose that calling terminal 102 places a call to called terminal 110. The call is placed through base station/gateway/interface 104 and geostationary satellite 106A. In this example, called terminal 110 is connected directly to geostationary satellite 106A, rather than through a base station or gateway. Both the calling terminal and the called terminal each have a smart vocoder.

Because bandwidth is typically very scarce for a geostationary satellite, it is very important to conserve bandwidth usage required by the call. In this case, smart vocoder 112 and smart vocoder 120 will decide during the signaling process to use a vocoder with a low bit rate to conserve bandwidth. For example, copending U.S. patent application Ser. No. 09/822,503 filed Apr. 2, 2001 (“Compressed Domain Universal Transcoder”) describes a very low bit rate (1.2 kbit/sec) subnarrowband vocoder that could be used to conserve bandwidth. Although, voice quality may be slightly degraded with the low bit rate vocoder, in this case, conserving bandwidth is more important than maximizing voice quality. Smart vocoder 112 thus selects the low bit rate vocoder.

On the other hand, when calling terminal 102 places a call to called terminal 116, the call is routed through the PSTN 106B, because called terminal 116 is connected to PSTN 106B. Conserving bandwidth is not so important for calls transmitted over the PSTN. In this case, the smart vocoder 112 will choose a vocoder with higher voice quality such as MELP (2.4 kbit/sec). Although the call will occupy twice the bandwidth of the 1.2 kbit/sec vocoder, the voice quality will be improved. In summary, FIG. 4 illustrates examples of smart vocoder operation for 1) conserving bandwidth, and 2) maximizing voice quality.

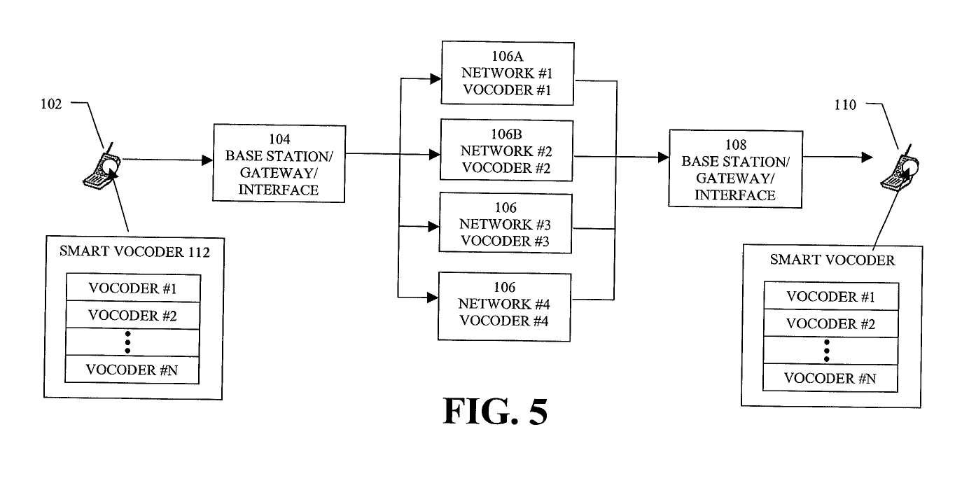

The smart vocoder can also select a vocoder based on minimizing the cost of the call. This is illustrated in FIG. 5. In this example configuration, a call from calling terminal 102 to called terminal 110 can be routed through any of four networks 106: network #1, network #2, network #3, and network #4. Each network is able to route communications only in one specific vocoder format. Network #1 routes communications only in vocoder #1 format. Network #2 routes communications only in vocoder #2 format, and so forth.

Each network 106 could be a satellite network, a terrestrial network, a wireline network, or a wireless network. As an example, network 106 could be IRIDIUM, a satellite network that routes communication in the advanced multi-band excitation (AMBE) vocoder format.

Suppose that calling terminal 102 places a call to called terminal 110. At the time of the call, network #3 has the lowest cost per minute for the call. Thus, during the call setup process, smart vocoder 112 determines that network #3 is the lowest cost network, and thus, vocoder #3 should be selected. Smart vocoder 112 therefore selects vocoder #3 and transmits the call to called terminal 110 encoded by vocoder #3 format. If network #3 is the IRIDIUM network, then smart vocoder 112 would select the AMBE vocoder algorithm for encoding the call.

Often a proprietary network such as a digital frame relay or asynchronous transfer mode (ATM) network will be cheaper than routing a call through the PSTN. Routing a call through the PSTN requires routing the call through the local Bell Telephone companies. They typically charge a higher rate because they have an effective monopoly. However, the proprietary networks are generally cheaper due to the increased competition.

Another feature that can be incorporated by the smart vocoder is the inclusion of one or more lossless compressors to create an additional bandwidth to allow for inclusion of channel coding. To explain, normally, when a terminal transmits a communication signal, the communication signal includes vocoder bits and perhaps also includes “channel coding,” also referred to as “error correction coding.” The terminal adds channel coding to increase the robustness of the communication. The more channel coding bits used, the more robust the communication is going to be. For example, wireless transmissions tend to be susceptible to the weather or other environmental conditions. If the terminal adds additional channel coding bits, the terminal can overcome these signal degradations due to the weather and environmental conditions.

Suppose a terminal needs to transmit a communication stream over a satellite link using the 1.2 kbit/sec vocoder. The link only provides an available bandwidth for the call of 1.3 kbit/sec. This leaves insufficient bandwidth available for the terminal to add error correction bits. One solution is for the terminal to use a lossless compressor to further compress the 1.2 kbit/sec signal, thereby creating some extra bandwidth to add forward error correction (FEC) bits. Once the 1.2 kbit/sec signal is compressed, the terminal can add FEC bits to the signal and still be able to transmit the signal over the 1.3 kbit/sec link.

The smart vocoder can thereby choose whether or not to use a compressor to create additional bandwidth, and whether to add FEC bits to increase the robustness of the communication. The drawback to using a compressor is that it adds latency (delay) to the signal. Therefore, the use of the compressor involves a tradeoff between robustness and latency. Usually, additional latency is not detrimental for data communications. However, for voice communications, latency can degrade the quality of the received voice communication.

The smart vocoder could also include multiple lossless compressors each of which compresses the signal a different amount. The smart vocoder could then choose which lossless compressor to use, and the smart vocoder could choose the number of FEC bits to add, based on criteria such as the bandwidth available on the link, the robustness of the link, weather and environmental conditions, etc.

The compressor is referred to as “lossless” because the after the signal is decompressed, the entire signal can be recovered. For example, if a 5 kbit/sec signal is compressed into a 4 kbit/sec signal by the lossless compressor, the receiving unit can decompress the signal and recover the original 5 kbit/sec signal.

This compressor feature is also particularly useful for military communciations because the compression and the additional channel coding can be used to overcome signal jamming. In a military environment, an enemy may try to interfere with a terminal's transmission. The enemy can either send signals at the same frequency as the terminal's carrier, or if the enemy can detect the terminal's particular timing, the enemy can actually jam the channel. One way to overcome jamming is by using forward error correction and interleaving. Interleaving spreads the communication and error over a larger time period, thereby increasing the chance that the error correction codes can conceal the error. The terminal thereby spreads the communications over a longer period of time, which helps to neutralize the jamming. For example, if the enemy jams for 5 milliseconds, the terminal can defeat the jam by using interleaving and thereby spreading the 5 msec communications over a longer time period. The receiving terminal can then recover the spread signal which was jammed during those five milliseconds.

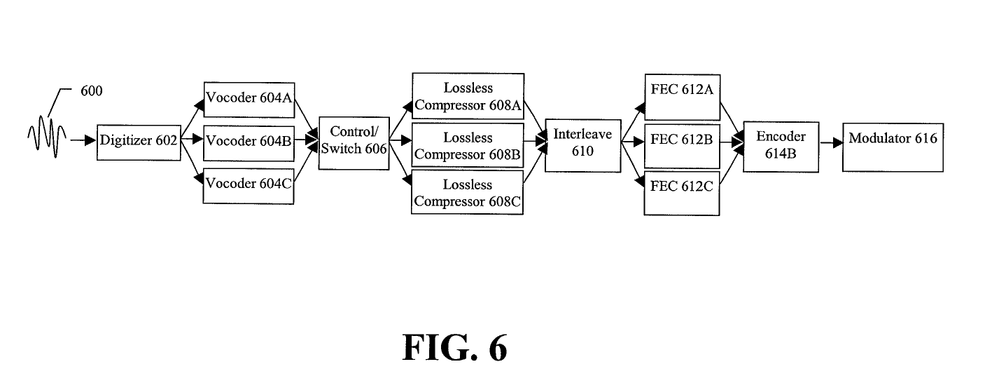

FIG. 6 depicts a block diagram illustrating operation of a smart vocoder that has the capability to select a vocoder and a lossless compressor. A voice signal 600 is applied to digitizer 602. Digitizer 602 digitizes the voice signal 600 and applies the digitized voice signal to vocoders 604. A control/switch unit 606 selects one of the vocoders 604A, 604B, or 604C to encode the digitized voice signal. One of these vocoders is selected based on the criteria discussed previously such as maximizing voice quality, preserving bandwidth, minimizing cost, achieving compatibility with a receiving unit, and/or reducing latency. After the voice signal has been encoded according to one of the vocoder algorithms, one of the lossless compressors 608A, 608B, or 608C is selected to compress the signal. As described previously, compressing the signal makes extra bandwidth available for forward error correction. The different lossless compressors achieve different amounts of compression. The drawback to compression is that additional latency is introduced.

After the signal has been compressed, interleave unit 610 interleaves the signal which spreads the communication signal over a longer time period. The interleaved signal is applied to one of FEC units 612A, 612B, or 612C. Each FEC unit applies a different amount of error correction bits. Only one of these units is selected. After the FEC bits have been added the signal is encoded by encoder 614B. The encoded signal is then added to an RF carrier signal by modulator 616. Modulator 616 may be, for example, an RF modulator. The RF signal is then transmitted to its destination.

The smart vocoder does not have to be incorporated into the communications terminal. Referring to FIG. 1, the smart vocoder 112 could alternatively be located in base station/gateway/interface 104, or any other network device. If the smart vocoder is incorporated into base station/gateway/interface 104, the calling terminal 102 will transmit the digitized voice signal to base station 104, and the base station 104 will choose the appropriate vocoder algorithm, and encode the signal accordingly. Incorporating the smart vocoder into the base station has the advantage that the smart vocoder can be used for all communication terminals linked to the base station, even if the communication terminal does not have its own built-in smart vocoder. It is also possible that both the communication terminal and the base station include a smart vocoder unit.

There are two ways that a smart vocoder can be physically incorporated into a communication terminal. The first way is to incorporate the smart vocoder into the communication terminal's digital signal processor (DSP). A communication terminal will have a baseband processor chip, a DSP. The DSP is typically a standardized chip with a fixed point processor and some memory. All of the vocoder algorithms and the logic for choosing a particular vocoder under various conditions can be programmed into the DSP.

The second way to incorporate the smart vocoder into the communication terminal is to develop one or more dedicated chips (an ASIC) which performs the smart vocoder functions. In this case, the smart vocoder will be hard-wired in the dedicated chip(s) to be compact and fast with low latency.

Incorporating the smart vocoder into the DSP is the cheaper method, unless the smart vocoder will be deployed for a large number of users. In this case, the cheaper and preferable method is to incorporate the smart vocoder into an ASIC or field programmable gate array (FPGA). This tends to be cheaper for a large number of users due to economies of scale. The development costs of the ASIC will be amortized over the number of users. If the smart vocoder logic is incorporated into the DSP, the DSP vendor will have to be paid a fee for every DSP to be programmed with the smart vocoder intelligence. However, if the smart vocoder is going to be mass produced for millions of users, the smart vocoder can be designed into an ASIC chip to reduce cost. The ASIC will also be slightly faster and thus have shorter latency. The ASIC will include all of the smart vocoder components illustrated in FIG. 6 such as the digitizer, vocoders, compressors, encoder, encryption unit, and so forth.

The ability to include a smart vocoder on an ASIC or in the DSP is only now possible through the tremendous increases in integrated circuit processing power that have been made over recent years. In recent years, the cost of DSPs has dropped rapidly while the storage capability has increased rapidly. Thus, much of the smart vocoder invention described herein would have been unthinkable 5-10 years ago. Today, it is possible to incorporate the smart vocoder of the present invention into a DSP or ASIC fairly cheaply.

A fairly cheap DSP or ASIC in a communication terminal handset can do 20-50 million instructions per second (MIPS). If the smart vocoder is incorporated into the base station, rather than the handset, cost is a less important factor. In this case, a chip which does several hundred MIPS is reasonable. Thus, the tremendous increases in processing power allow the vocoder intelligence to be performed on a small chip with very little delay. Of course, in the years to come, the processing power will continue to increase at lower and lower cost.

The smart vocoder could potentially include a user interface which allows the user to choose settings for the smart vocoder. For example, a user could specify that the vocoder algorithm should be selected based on minimizing bandwidth. As another example, the user could specify that the smart vocoder should select a vocoder based on primarily the best voice quality, and secondarily lowest cost.

The smart vocoder could also potentially utilize a compressed domain transcoder. Compressed domain transcoders are described in copending U.S. patent application Ser. No. 09/822,503 filed Apr. 2, 2001 (“Compressed Domain Universal Transcoder”). A compressed domain transcoder converts a voice signal encoded in a first vocoder format to a signal encoded in a second vocoder format without decompressing the signal to a PCM format. For example, a MELP-encoded bit stream could be converted to a time domain voicing cutoff (TDVC) encoded bit stream by a MELP-to-TDVC compressed domain transcoder. Thus, the smart vocoder could choose to transmit a MELP encoded bit stream to the base station, and then the base station could use a compressed domain transcoder to convert from MELP to TDVC.

Although the systems and methods of the present invention have been described in connection with preferred embodiments, it is not intended to be limited to the specific form herein. On the contrary, it is intended to cover such alternatives, and equivalents, as can be reasonably included within the spirit and scope of the invention as defined by the appended claims.

What is claimed is:

1. A method of encoding a communication for transmission over a communications network, comprising:
selecting one of a plurality of vocoder algorithms, the selection based on at least one of the following criteria:
a) minimizing bandwidth required to transmit the communication;
b) minimizing a cost of transmitting the communication;
c) increasing the quality of the communication;
d) achieving compatibility with a receiving terminal; and
e) reducing latency;
encoding the communication with the selected vocoder algorithm; and
transmitting the communication signal.

2. The method of claim 1, wherein the selection of one of the plurality of vocoder algorithm occurs during a call setup.

3. The method of claim 1, wherein the communication is transmitted from a calling terminal to a called terminal without converting the communication to a waveform representation.

4. The method of claim 1, wherein a low bit rate vocoder algorithm is selected if bandwidth is scarce.

5. The method of claim 1, wherein a vocoder algorithm is selected which allows the call to be routed over a low cost network.

6. The method of claim 1, further comprising:
adding error correction to the transmitted communication signal.

7. The method of claim 6, further comprising:
compressing the encoded communication signal before adding error correction.

8. The method of claim 7, further comprising:
decompressing the encoded communication signal at a called terminal.

9. The method of claim 6, wherein the compression is performed by a lossless compressor.

10. The method of claim 6, further comprising:
selecting one of a plurality of compression algorithms to compress the encoded communication signal.

11. The method of claim 6, further comprising:
interleaving the communication signal to defeat jamming.

12. The method of claim 1, further comprising:
converting the encoded communication signal to a different coding standard by use of a compressed domain transcoder.

13. A smart vocoder, comprising:
a memory storing a plurality of vocoder algorithms;
a smart vocoder unit selecting an optimal vocoder algorithm from one of the plurality of vocoder algorithms; and
an encoder encoding a communication signal according to the selected vocoder algorithm.

14. The smart vocoder of claim 13, wherein the smart vocoder unit selects an optimal vocoder algorithm based on at least one of the following criteria:
a) minimizing bandwidth required to transmit the communication;
b) minimizing a cost of transmitting the communication;
c) increasing the quality of the communication;
d) achieving compatibility with a receiving terminal; and
e) reducing latency.

15. The smart vocoder of claim 14, wherein the smart vocoder unit is located in a communication terminal or a base station.

16. The smart vocoder of claim 14, wherein the smart vocoder is incorporated into a DSP.

17. The smart vocoder of claim 14, wherein the smart vocoder is included in one or more dedicated ASICs.
